(19) United States
(12) Patent Application Publication
(10) Pub. No.: US 2017/0091228 A1
(43) Pub. Date: Mar. 30, 2017

(54) METHOD AND SYSTEM FOR READING CONSISTENT DATA FROM A MULTI-MASTER REPLICATED DATABASE

(71) Applicant: GOOGLE INC., Mountain View, CA (US)

(72) Inventors: Stephen Paul MIDDLEKAUFF, Mountain View, CA (US); Jeffrey KORN, Mountain View, CA (US); Jinyuan LI, Mountain View, CA (US)

(73) Assignee: GOOGLE INC., Mountain View, CA (US)

(21) Appl. No.: 13/850,882

(22) Filed: Mar. 26, 2013

(51) Int. Cl. G06F 17/30

(52) U.S. Cl. CPC G06F 17/30289

(57) ABSTRACT

Methods, systems, and architectures are provided for allowing a consistent view (e.g., read-after-write) from a replicated database that uses asynchronous replication (e.g., eventual consistency of data across related databases) without the use of a master replicated database. A replication “low water mark” for a replica includes a timestamp of the most recent write that has fully replicated to the replica, and therefore indicates that the replica is current as of time “X”. By using the difference between the present moment in time (e.g., “now”) and the last write timestamp received via replication, it is possible to determine how delayed a given replica is.

### TECHNICAL FIELD

The present disclosure generally relates to data replication in distributed systems. More specifically, aspects of the present disclosure relate to reading consistent data from a replicated database without using a master replica.

### BACKGROUND

When storing data in a replicated database that uses asynchronous replication (e.g., eventual consistency of data across different databases), it is difficult to provide accurate read-after-write results. For example, “User A just wrote X. Ensure that when User A performs another read, User A gets X back.” Reading data from any replicated database that did not receive the write may not yield the expected results due to the delay inherent in asynchronous replication.

A common approach to avoiding the above complication is to elect a “master” replica (e.g., database) through which all writes and consistent reads occur. However, designating one replica as a master greatly reduces availability and scalability, and may also introduce latency (e.g., in scenarios where the master replica database is located far away). On the other hand, this approach does offer read-after-write semantics.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a method comprising: reading data contained at a first replicated database and a data structure; determining a timestamp of a last replicated write to the first replicated database; comparing the timestamp of the last replicated write to a timestamp of the data structure; determining, based on the comparison, that the timestamp of the data structure is greater than the timestamp of the last replicated write to the first replicated database; and responsive to determining that the timestamp of the data structure is greater than the timestamp of the last replicated write to the first replicated database, issuing a data read from another replica of the first replicated database.

According to another embodiment, the method further comprises, in response to determining that the timestamp of the data structure is not greater than the timestamp of the last replicated write to the first replicated database, determining that all data has replicated to the first replicated database.

According to another embodiment, the method further comprises: mapping an identifier of the first replicated database to the timestamp of the data structure; and storing the mapping of the identifier and the timestamp of the data structure.

According to yet another embodiment, the method further comprises: mapping an identifier of the first replicated database to the timestamp of the data structure; serializing the mapping of the identifier and the timestamp of the data structure; and distributing the serialized mapping to one or more other replicated databases.

According to still another embodiment, the method further comprises: in response to a write being sent to the first replicated database, determining that the first replicated database exists in the data structure; and updating the data structure based on a timestamp of the write sent to the first replicated database.

Another embodiment of the present disclosure relates to a distributed storage system comprising a plurality of servers in communication over a network, each of the plurality of servers configured to: read data contained at a first replicated database and a data structure; determine a timestamp of a last replicated write to the first replicated database; compare the timestamp of the last replicated write to a timestamp of the data structure; determine, based on the comparison, that the timestamp of the data structure is greater than the timestamp of the last replicated write to the first replicated database; and responsive to determining that the timestamp of the data structure is greater than the timestamp of the last replicated write to the first replicated database, issue a data read from another replica of the first replicated database.

According to another embodiment of the distributed storage system, each of the plurality of servers is further configured to, in response to determining that the timestamp of the data structure is not greater than the timestamp of the last replicated write to the first replicated database, determine that all data has replicated to the first replicated database.

According to another embodiment of the distributed storage system, each of the plurality of servers is further configured to: map an identifier of the first replicated database to the timestamp of the data structure; and store the mapping of the identifier and the timestamp of the data structure.

According to yet another embodiment of the distributed storage system, each of the plurality of servers is further configured to: map an identifier of the first replicated database to the timestamp of the data structure; serialize the mapping of the identifier and the timestamp of the data structure; and distribute the serialized mapping to one or more other replicated databases.

According to still another embodiment of the distributed storage system, each of the plurality of servers is further configured to: in response to a write being sent to the first replicated database, determine that the first replicated database exists in the data structure; and update the data structure based on a timestamp of the write sent to the first replicated database.

According to one or more other embodiments, the methods and systems described herein may optionally include one or more of the following additional features: the data structure contains one or more timestamps for one or more other replicated databases; the data contained at the first replicated database and the data structure includes information about writes replicated from one or more other replicated databases; the first replicated database is a local database; the another replicated database is a remote database; and/or the data structure is serialized into a HTTP cookie.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the disclosure will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a flowchart illustrating an example method for reading.

FIG. 2 is a block diagram illustrating an example arrangement of replicated databases and a consistent read operation according to one or more embodiments described herein.

FIG. 3 is a block diagram illustrating an example arrangement of replicated databases and a multi-master write operation according to one or more embodiments described herein.

FIG. 4 is a block diagram illustrating an example arrangement of replicated databases and a consistent read operation with data backfilling according to one or more embodiments described herein.

FIG. 5 is a table illustrating example replication low water marks according to one or more embodiments described herein.

FIG. 6 is a block diagram illustrating an example computing device for implementing consistent data views from a multi-master replicated database according to one or more embodiments described herein.

The headings provided herein are for convenience only and do not necessarily affect the scope or meaning of what is claimed in the present disclosure.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples of the invention will now be described. The following description provides specific details for a thorough understanding and enabling description of these examples. One skilled in the relevant art will understand, however, that the disclosure may be practiced without many of these details. Likewise, one skilled in the relevant art will also understand that the disclosure may include many other obvious features not described in detail herein. Additionally, some well-known structures or functions may not be shown or described in detail below, so as to avoid unnecessarily obscuring the relevant description.

In a distributed data storage system for managing structured data, one or more multi-master replicated databases may be used for storage of the data. In the present context, “replication” refers to the process of copying and maintaining database objects (e.g., tables) in multiple databases that together comprise a distributed database system. With asynchronous replication, changes applied at one site are captured and stored locally (e.g., in a local database) before being propagated and applied at each of the remote locations. However, basic read-after-write flows may not yield consistent data due to, among other things, asynchronous replication fail-overs of reads and/or writes, and a general lack of “stickiness” at every level of the stack.

Embodiments of the present disclosure relate to methods, systems, and architectures for providing a consistent view (e.g., read-after-write) from a replicated database (sometimes referred to herein simply as a “replica” for brevity) that uses asynchronous replication (e.g., eventual consistency of data across related databases) without the use of a master replica. Data replication is generally performed using either a push model (e.g., the replica that receives the write pushes the data to all the other replicas) or a pull model (e.g., each replica pulls writes from all the sources, polling for new updates at a set time interval, such as every “N” seconds (where “N” is an arbitrary number)). The data replication may not be immediate, and often there is a backlog of writes to replicate. When a write is committed to a replica, the write may be given a timestamp. As such, the replication destination receives a set of writes along with corresponding timestamps for each. Additionally, the writes are sent/received in order.

The methods, systems, and architectures for data replication provided herein offer both scalability and fault tolerance advantages. The embodiments described below utilize replicas that offer eventual consistency such that when a user writes to one replica, the write is propagated out to the other replicas. An environment such as this is scalable and fault tolerant in that if one replicated database fails, a user can write to and/or read from another replicated database. Although it is possible that the user may be reading “stale” data (e.g., if the other replica has not been recently updated with the same data stored in the failed replica), for many applications, having some available data is better than having no data at all, and therefore using stale data in this manner does not present any problems. However, for some applications, using stale data can cause problems.

For example, some applications involve saving and maintaining very visible user data, such as application settings, user preferences, and the like. In the context of these applications, a user would find it extremely frustrating and disruptive if the user's selected settings/preferences switched back and forth between different uses of the application. For example, where a user selects “English” as her preferred language for a particular application, it would be problematic if, at different times, the application went from using English to French, and then back to English again.

In one approach, a server cookie (e.g., an opaque ASCII string) may be passed back and forth between the management server and clients. In many of the embodiments and examples described herein, this server cookie is referred to as a “version cookie”. The version cookie contains (data class, timestamp) pairs for the most recent write, and optionally may also include a table hint (e.g., the table the most recent write was applied to, regardless of the data class). The timestamp in the pair is from the mutation (e.g., the update to the replica), and entries in the version cookie are discarded after a predetermined period of time (e.g., after “N” minutes, where “N” is an arbitrary number) typically configured to be the replication delay in an assumed worst case scenario.

The storage system can use the information contained in the version cookie to provide a level of assurance that data returned to the client is at least as new as the last mutation (e.g., update). For example, the logic may be that, for a given replicated database, if any data has been read with a timestamp ≧the timestamp contained in the version cookie, then the particular replica is “consistent” and so is the read operation. However, as described above, there are cases where this data may not actually be consistent. For example, consider the straightforward case where there are two replicas, “A” and “B”, and a write to each replica at T₁₀ and T₂₀, respectively. A client may have a version cookie from either write, and a read from replica B will always be “consistent”, even if the write at T₁₀ has not yet replicated to replica B.

Accordingly, embodiments of the present disclosure relate to data storage methods, systems, and architectures that provide increased availability of read/write options while also offering read-after-write consistency semantics. In at least one embodiment, replication “low water marks” are used.

As used herein, a replication “low water mark” (sometimes abbreviated herein as “LWM”) is the most recent write that has replicated to a given replica. In other words, a replication low water mark for a given replica may be thought of as a replication timestamp, which indicates that the replica is current as of time “X”. For example, if a user writes to replica “A” at time T₁₀₀, and at time T₂₀₀ replica “B” sees the write at T₁₀₀, then the low water mark for replica B is 100. In some scenarios, there might be other writes that have also occurred, but have not yet replicated to replica B. As such, in at least some embodiments, the low water mark for a given replica can be defined as the most recent write that has fully replicated to the replica. By using the difference between the present moment in time (e.g., “now”) and the last write timestamp received via replication, it is possible to determine how “behind” (e.g., delayed) a given replica is.

One or more embodiments described herein relate to extending a replicated database to return low water marks from each of the other replicas as part of the read operation. For example, when reading from “Replica A”, the database may return information corresponding to the following: “Replica A has only seen writes up to T₁₀ from Replica B, T₁₂ from Replica C, and T₈ from Replica D.”

On the client side, a data structure is used to maintain the timestamp of the last write to each replica. For example, a simple implementation may use a mapping of “replica name” to “timestamp of last write.” When a write is sent to a replica already in the data structure, the timestamp is updated. In at least some embodiments, a replica that has never been written to does not need to be included in the data structure.

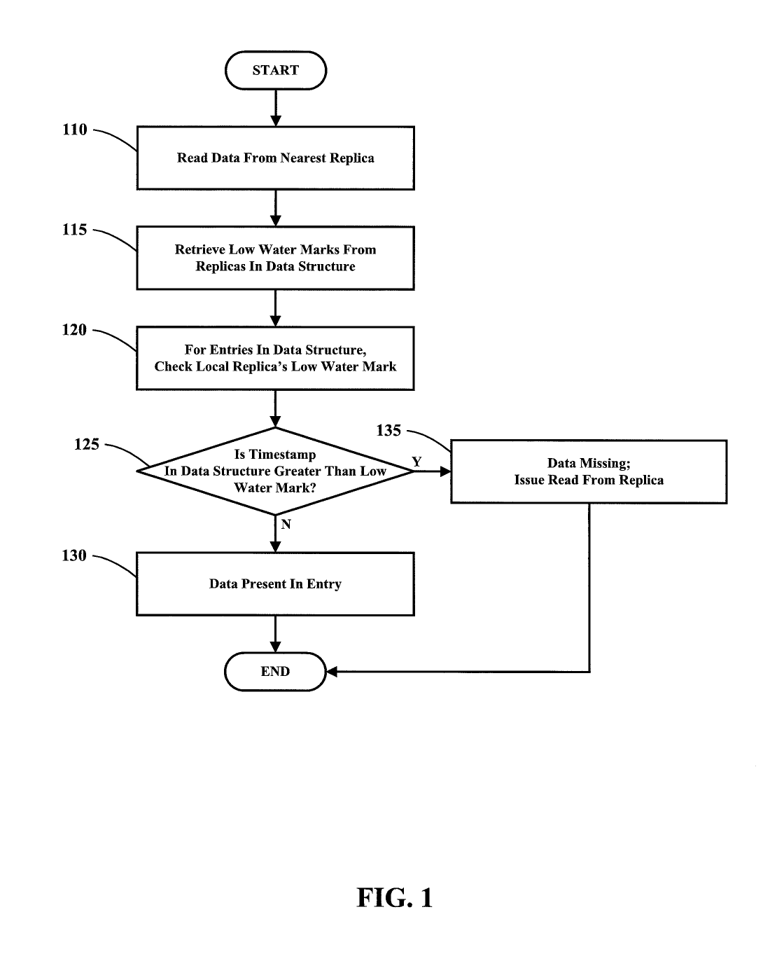

Given the example data structure described above, combined with the ability to determine (e.g., read) what data has been replicated to a given replica (e.g., the “low water marks”), the methods and systems described herein ensure that a read returns consistent data by implementing any one or more of a number of strategies. One example of such a strategy is presented below and illustrated in FIG. 1. This example strategy was chosen for the purpose of illustration because it balances network load and overall latency:

1. Read data from the nearest replica, and fetch the low water marks for the replica (steps 110 and 115 as shown in FIG. 1).

2. For an entry in the data structure, check the watermark of the local replica (step 120).

3. Determine whether the timestamp in the data structure is less than or equal to the low water mark (in terms of time, e.g., milliseconds (ms)) (step 125).

4. If it is determined that the timestamp in the data structure is less than or equal to the low water mark, the data is present in the entry (step 130).

5. If it is determined that the timestamp is greater than the low water mark, then some data may be missing. For an entry that may be missing data, issue a read from that replica (step 135).

6. Merge the results from one or more reads into a comprehensive assessment or evaluation.

Additionally, entries may be removed/ignored after the low watermark of the particular tablet is greater than the timestamp of the entry.

It should be noted that the above strategy is only one example of a variety of strategies that may be implemented in accordance with embodiments described herein. Numerous other strategies may also be used in addition to or instead of the example presented above, which is not in any way intended to limit the scope of the present disclosure.

In at least some embodiments, the mapping of the replica name to timestamp can be serialized and passed around to other components in the data structure, while in other embodiments, the mapping can simply be stored for later use or retrieval.

It should be noted that for web applications, the data structure may be serialized into a HTTP cookie that is exchanged between a user's browser and the server. The server will use the data structure to provide a consistent view of the data even if one request is sent to a data center in a first geographic location (e.g., Atlanta) and the next request is handled in a second geographical location (e.g., Oregon), and replication has not yet occurred.

According to one or more embodiments of the present disclosure, the payload of the version cookie may include one or more entries. An entry may be, for example, a (replica fingerprint, timestamp) pair, where the timestamp is “now”. Therefore, this approach keeps track of a per-replica timestamp (instead of a single timestamp for a data class).

Furthermore, in at least one implementation, a set/mutation may update the version cookie with the timestamp of the mutation and the particular replica the mutation was applied to. In some scenarios, this update may involve modifying an existing entry (e.g., updating the timestamp), or adding a new entry (e.g., if a new replica is used). Depending on the implementation, if a version cookie is present at the start of the operation, then the operation may prefer to use a replica in an existing entry.

In at least some embodiments of the disclosure, the version cookie may continue to use custom encoding to maintain compactness, and may additionally use the following example format:

Version Cookie :=Version+UserKey+TableGroupSize+TableGroup

Version:=4 bits int

UserKey:=64 bit fingerprint of the UserKey

TableGroupSize:=5 bits

TableGroup:=(TableSpec, Timestamp) |TableGroup

TableSpec:=64 bit fingerprint of the MasterTable fullname

Timestamp:=42 bits absolute ts, 30 bits delta ts

It should be noted that the timestamp encoding allows for absolute timestamps until some predetermined future time (e.g., year 2248), and allows for delta timestamps some period of time (e.g., 24 days) past the baseline. Additionally, in at least one example scheme, TableGroups may be sorted in reverse chronological order, and the first entry may have an absolute timestamp. Subsequent table groups are then relative to the absolute timestamp.

Under the scheme proposed above, the encoded size (in, for example, bytes) may be as follows:

v₁ (each cookie has random 1-10 dataclasses): Average length: 41; Maximum length: 78; Minimum length: 12.

v₂ (each cookie has random 1-10 fingerprints of table names): Average length: 90; Maximum length: 162; Minimum length: 20.

Because VersionInfo contains (replica, timestamp) pairs for replicas that were last written to, and since water marks may be fetched, the following is therefore known: (1) reading directly from a replica yields results written to the replica; and (2) per-replica water marks may be used to determine what data has been replicated from remote replicas to the local replica.

One example implementation may send parallel lookups to replicas in the VersionInfo, merging the response streams. With such an implementation, it is not necessary to inspect the responses since the previous writes to the replicas are likely to have been read.

In accordance with at least one embodiment, an effective approach might read from the nearest replica, reading the watermarks and back-filling data as necessary. With such an approach, the per-replica watermarks from the local replica can be compared against the timestamps in the VersionInfo to determine what data is missing. For example, for a given replica “R”, if the watermark of replica R >the VersionInfo timestamp of R, then all of the writes to replica R have been replicated and read. On the other hand, if the watermark of replica R <the VersionInfo timestamp of R, then a read may be issued directly to R (or to any replica where the watermark of the replica ≧the VersionInfo timestamp of the replica).

In one or more other embodiments, a hybrid approach may be utilized, reading from local and all replicas in the VersionInfo, with watermarks. Under such an approach, when a scan is complete, the watermarks may be used to determine if complete data has been read. For example, consider replicas “local”, “mid”, and “far”, and the following VersionInfo:

“local” watermarks: {mid@120, far@70}

“mid” watermarks: {local @120, far@210}

“far” watermarks: {local @100, mid@120}

VersionInfo: {mid@100, far@200 }

T₁: send out parallel reads to “local”, “mid”, and “far”.

T₂: read from “local” completes, there is consistent data from “mid”, but not from “far”.

T₅: read from “mid” completes, there is now consistent data from “far”. Cancel “far” read.

T₁₀: “far” read would have completed, but it was canceled.

In at least some embodiments, if a replica in the VersionInfo is unreachable for any reason, the server may attempt to locate the data elsewhere (e.g., using watermarks, as described above). There are a number of strategies that may be implemented in such a scenario including, for example, stepped fail-over, exponentially increasing parallel reads (e.g., read from the next nearest replica, then the next two nearest replicas, the next four nearest replicas, etc.), or reading from all replicas in parallel. Depending on how efficient cancelation is, it may also make sense in such a scenario to send all reads in parallel and cancel once the data missing from the replica has been read.

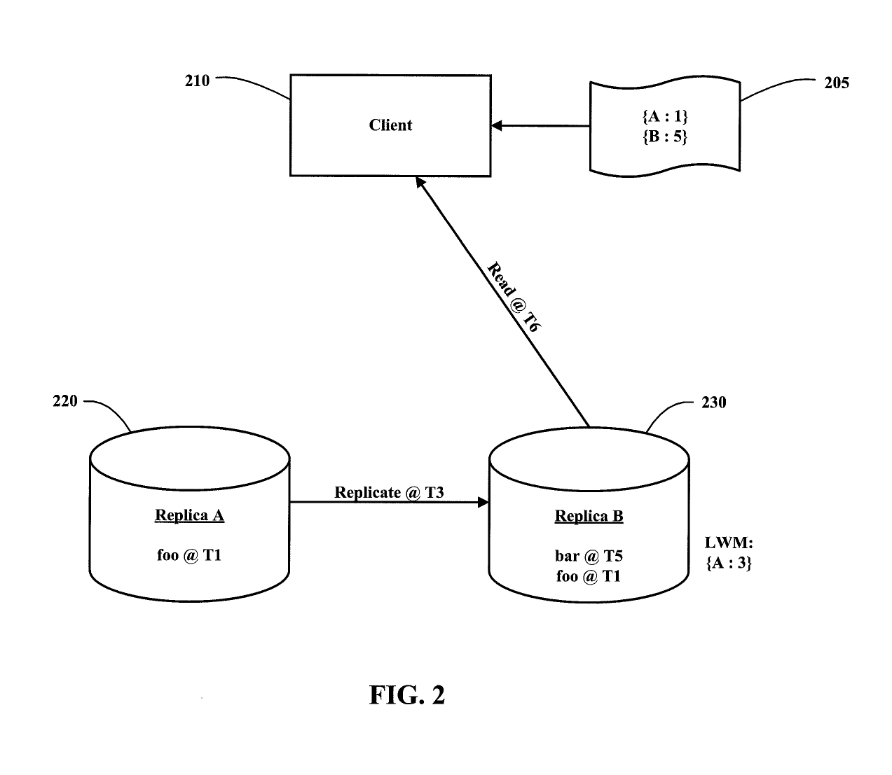

FIG. 2 illustrates an example arrangement of replicated databases and a consistent read operation according to one or more embodiments described herein. In the example shown, the data in Replica A 220 includes writes up to T₁ (e.g., foo @ T₁). At T₃, the most recent write to Replica A (e.g., foo @ T₁) replicates to Replica B 230. Replica B 230 also contains an additional write at T₅ (e.g., bar @ T₅). Accordingly, Replica B 230 has a low water mark of 3. At T₆, the data from Replica B 230 is read by the client 210.

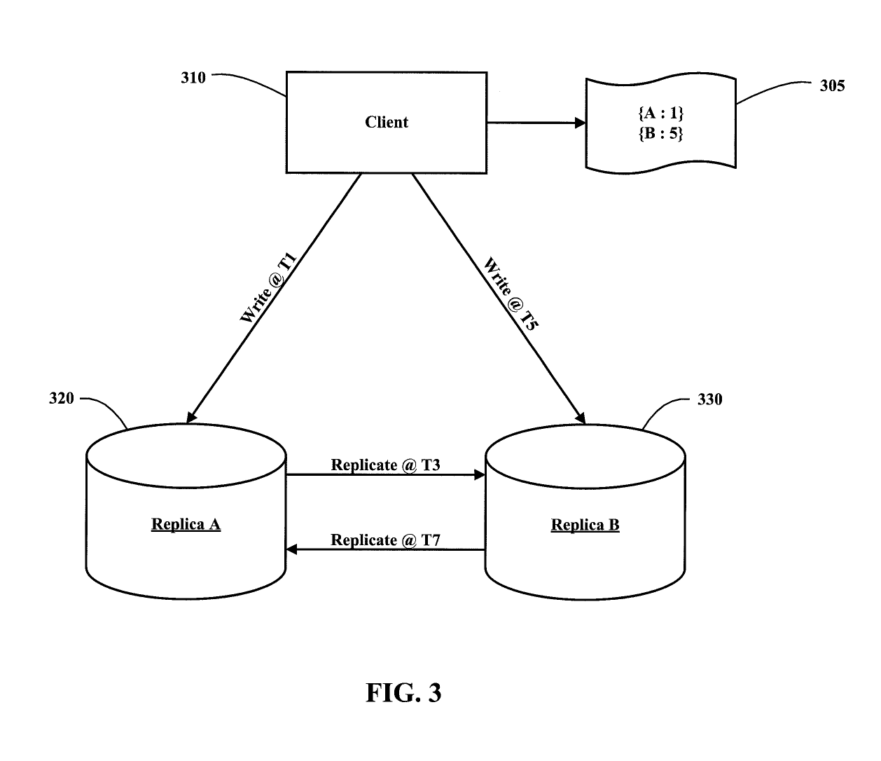

FIG. 3 illustrates an example arrangement of replicated databases and a multi-master write operation according to one or more embodiments described herein. Similar to the arrangement described above and illustrated in FIG. 2, the example arrangement shown in FIG. 3 includes a client 310 and two replicated databases, Replica A 320 and Replica B 330.

At time T₁, the client 310 writes to Replica A 320 (represented as “Write @ T₁”) and updates the data structure 305 to reflect the operations, e.g., by inserting the pair (A, T₁). At time T₃, the write to Replica A 320 (from the client 310 at time T₁) replicates to Replica B 330. At time T₅, the client 310 writes to Replica B 330 (represented as “Write @ T₅”) and updates the data structure 305 to reflect the write operation, e.g., by inserting the pair (B, T₅). At time T₇, the write to Replica B 330 (from the client 310 at time T₅) replicates to Replica A 320.

In accordance with at least one embodiment of the disclosure, given the data structure 305 at any point in time (e.g., T₂, T₄, . . . , Tₙ (where “n” is an arbitrary number)), a consistent read operation may be performed.

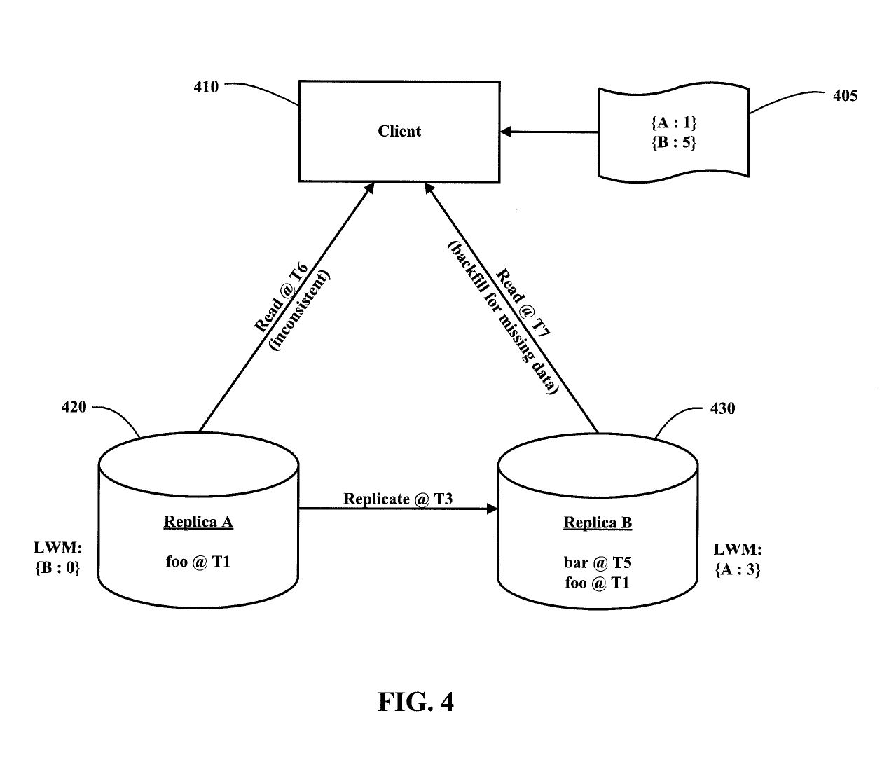

FIG. 4 is a block diagram illustrating the example arrangement of replicated databases and a consistent read operation with data backfilling according to one or more embodiments described herein. The example arrangement shown in FIG. 4 may be considered similar to the example arrangement of replicated databases shown in FIG. 3 and described above. In particular, the arrangement shown in FIG. 4 includes the client 410 and two replicated databases, Replica A 420 and Replica B 430. Additionally, for purposes of simplicity, the following description of the operations shown in FIG. 4 continues with the same example scenario described above and illustrated in FIG. 3. Therefore, reference may be made to both FIGS. 3 and 4 in the description below.

Assuming the state illustrated in FIG. 3, the operations shown in FIG. 4 begin at time T₆, where the client 410 issues a consistent read. It is important to note that the client 410 issues this read operation (at time T₆) before the write to Replica B (represented in FIG. 3 as “Write @ T₅” from the client 310 to Replica B 330) has fully replicated to Replica A (represented in FIG. 3 as “Replicate @ T₇”). Therefore, if the client 410 were to select Replica B 430 to read from first, the operation would be consistent since Replica B 430 is storing all of the current data.

On the other hand, suppose Replica A 420 is the nearest available database for the client 410, and thus the client 410 selects Replica A 420 to read from first. Under this scenario, at time T₆, the client 410 reads from Replica A 420 (represented in FIG. 4 as “Read @ T₆”) and fetches the LWM. As of time T₆, the write to Replica B 430 has not replicated to Replica A 420 (represented in FIG. 3 as “Replicate @ T₇”), and therefore the LWM returned to the client 410 contains {B=0}. Comparing the returned LWM with the corresponding data structure, the client 410 can determine that it is missing data written to Replica B 430 (e.g., LWM 5 >LWM 0). As a result of this determination, the client 410 may issue a read operation to Replica B 430 at time T₇ to “backfill” the missing data (represented in FIG. 4 as “Read @ T₇”).

Continuing with the above scenario, following the read operation to Replica B 430 at time T₇, the client has read:

from Replica A: foo@ T₁

from Replica B: bar@ T₅ and foo@ T₁

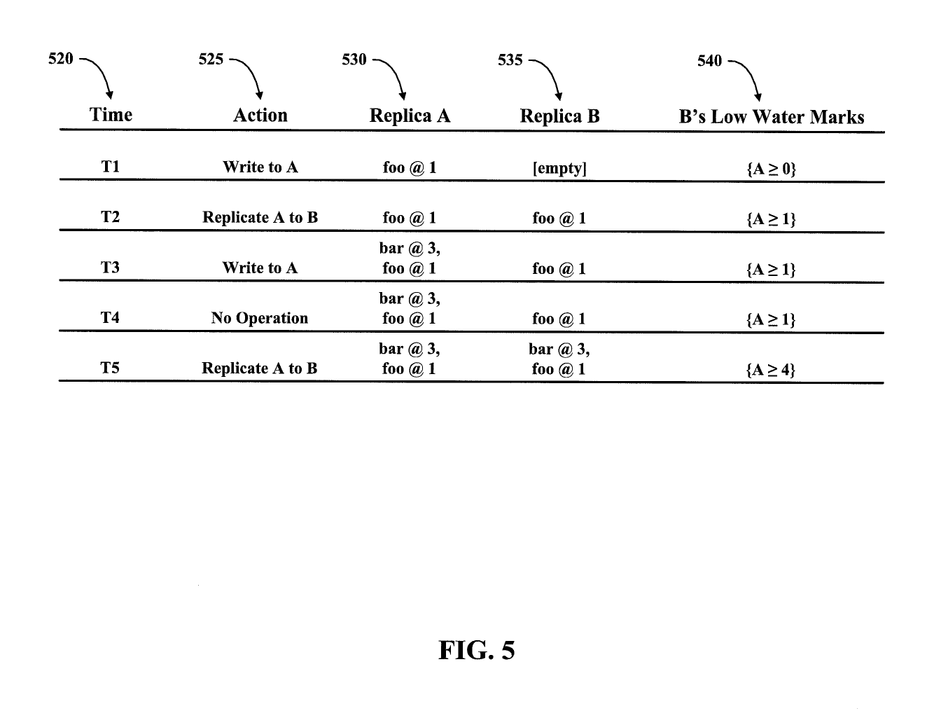

FIG. 5 is a table illustrating example replication low water marks according to one or more embodiments described herein. The example table shown identifies, at each of five time instants 520, a corresponding action 525, data stored at Replica A, data stored at Replica B, and Replica B's low water marks.

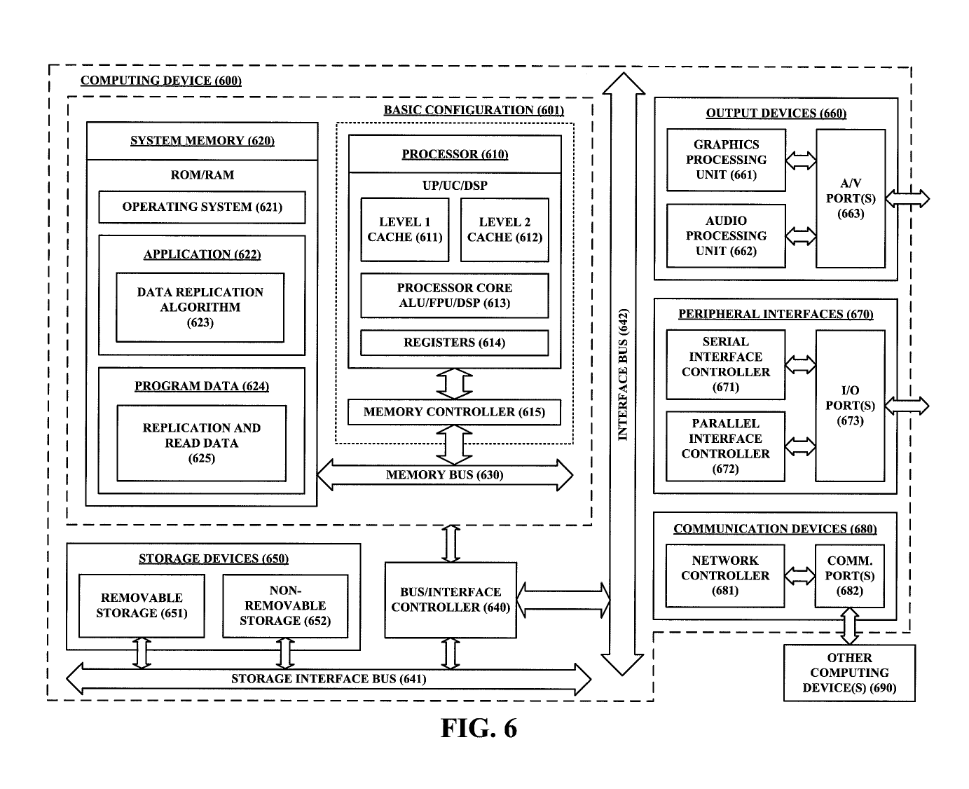

FIG. 6 is a block diagram illustrating an example computing device 600 that is arranged for implementing consistent data replication and viewing in distributed systems in accordance with one or more embodiments of the present disclosure. In a very basic configuration 601, computing device 600 typically includes one or more processors 610 and system memory 620. A memory bus 630 can be used for communicating between the processor 610 and the system memory 620.

Depending on the desired configuration, processor 610 can be of any type including but not limited to a microprocessor (μP), a microcontroller (μC), a digital signal processor (DSP), or any combination thereof Processor 610 can include one more levels of caching, such as a level one cache 611 and a level two cache 612, a processor core 613, and registers 614. The processor core 613 can include an arithmetic logic unit (ALU), a floating point unit (FPU), a digital signal processing core (DSP Core), or any combination thereof A memory controller 615 can also be used with the processor 610, or in some implementations the memory controller 615 can be an internal part of the processor 610.

Depending on the desired configuration, the system memory 620 can be of any type including but not limited to volatile memory (such as RAM), non-volatile memory (such as ROM, flash memory, etc.) or any combination thereof System memory 620 typically includes an operating system 621, one or more applications 622, and program data 624. Application 622 includes data replication algorithm 623 that is arranged to perform data replication and read operations in a distributed system. Program Data 624 includes replication and read data 625 that is useful for performing replication and read operations in distributed systems, as will be further described below. In some embodiments, application 622 can be arranged to operate with program data 624 on an operating system 621 such that reading consistent data from replicated databases in distributed systems is performed without the use of a master replica. This described basic configuration is illustrated in FIG. 6 by those components within dashed line 601.

Computing device 600 can have additional features or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or a combination thereof Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of device 600.

Computing device 600 can also include an interface bus 642 for facilitating communication from various interface devices (e.g., output interfaces, peripheral interfaces, and communication interfaces) to the basic configuration 601 via the bus/interface controller 640. Example output devices 660 include a graphics processing unit 661 and an audio processing unit 662, which can be configured to communicate to various external devices such as a display or speakers via one or more A/V ports 663. Example peripheral interfaces 670 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673. An example communication device 680 includes a network controller 681, which can be arranged to facilitate communications with one or more other computing devices 690 over a network communication via one or more communication ports 682.

The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 600 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising: occur
reading data contained at a first replicated database, wherein the data includes a timestamp of a last replicated write to the first replicated database;
obtaining a per-replica timestamp from the first replicated database, wherein the per-replica timestamp indicates when most recent writes have fully replicated to the first replicated database from one or more other replicated databases associated with the first replicated database;
comparing the per-replica timestamp from the first replicated database with a last write timestamp of a data structure, wherein the last write timestamp of the data structure indicates when last writes of complete data to the one or more other replicated databases have occurred;
when the timestamp of the data structure is greater than the per-replica timestamp from the first replicated database:
determining that the first replicated database is missing data written to the one or more other replicated databases; and
issuing a data read from the one or more other replicated databases associated with the first replicated database to backfill the missing data.

2. The method of claim 1, further comprising:
responsive to determining that the timestamp of the data structure is not greater than the per-replica timestamp from the first replicated database, determining that all data has replicated to the first replicated database.

3. The method of claim 1, further comprising:
mapping an identifier of the first replicated database to the timestamp of the data structure; and
storing the mapping of the identifier and the timestamp of the data structure.

4. The method of claim 1, further comprising:
mapping an identifier of the first replicated database to the timestamp of the data structure;
serializing the mapping of the identifier and the timestamp of the data structure; and
distributing the serialized mapping to one or more other replicated databases.

5. The method of claim 1, wherein the data structure contains one or more last write timestamps for the one or more other replicated databases associated with the first replicated database.

6. (canceled)

7. The method of claim 1, further comprising:
responsive to a write being sent to the first replicated database, determining that the first replicated database exists in the data structure; and
updating the data structure based on a timestamp of the write sent to the first replicated database.

8. The method of claim 1, wherein the first replicated database is a local database.

9. The method of claim 1, wherein the another replicated database is a remote database.

10. The method of claim 1, wherein the data structure is serialized into a HTTP cookie.

11. A distributed storage system comprising:
a plurality of servers in communication over a network, each of the plurality of servers configured to:
read data contained at a first replicated database, wherein the data includes a timestamp of a last replicated write to the first replicated database;
obtain a per-replica timestamp from the first replicated database, wherein the per-replica timestamp indicates when most recent writes have fully replicated to the first replicated database from one or more other replicated databases associated with the first replicated database;
compare the per-replica timestamp from the first replicated database with a last write timestamp of a data structure, wherein the last write timestamp of the data structure indicates when last writes of complete data to the one or more other replicated databases have occurred;
when the timestamp of the data structure is greater than the per-replica timestamp from the first replicated database:
determine that the first replicated database is missing data written to the one or more other replicated databases; and
issue a data read from the one or more other replicated databases associated with the first replicated database to backfill the missing data.

12. The distributed storage system of claim 11, wherein each of the plurality of servers is further configured to:
responsive to determining that the timestamp of the data structure is not greater than the per-replica timestamp from the first replicated database, determine that all data has replicated to the first replicated database.

13. The distributed storage system of claim 11, wherein each of the plurality of servers is further configured to:
map an identifier of the first replicated database to the timestamp of the data structure; and
store the mapping of the identifier and the timestamp of the data structure.

14. The distributed storage system of claim 11, wherein each of the plurality of servers is further configured to:
map an identifier of the first replicated database to the timestamp of the data structure;
serialize the mapping of the identifier and the timestamp of the data structure; and
distribute the serialized mapping to one or more other replicated databases.

15. The distributed storage system of claim 11, wherein the data structure contains one or more last write timestamps for the one or more other replicated databases associated with the first replicated database.

16. (canceled)

17. The distributed storage system of claim 11, wherein each of the plurality of servers is further configured to:
responsive to a write being sent to the first replicated database, determine that the first replicated database exists in the data structure; and
update the data structure based on a timestamp of the write sent to the first replicated database.

18. The distributed storage system of claim 11, wherein the first replicated database is a database local to at least one of the plurality of servers.

19. The distributed storage system of claim 11, wherein the another replicated database is a database remote to at least one of the plurality of servers.

20. The distributed storage system of claim 11, wherein the data structure is serialized into a HTTP cookie.
